(19) United States
(12) Patent Application Publication
(10) Pub. No.: US 2006/0257808 A1
(43) Pub. Date: Nov. 16, 2006

(54) Orthodontic appliance attachment

(76) Inventor: Jedediah M. Feller, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/417,603

(22) Filed: May 3, 2006

Related U.S. Application Data
(63) Continuation-in-part of application No. 11/120,823, filed on May 3, 2005.
(60) Provisional application No. 60/573,704, filed on May 21, 2004.
(60) Provisional application No. 60/759,317, filed on Jan. 17, 2006.

(51) Int. Cl. A61C 3/00

(52) U.S. Cl. 433/2

(57) ABSTRACT

An attachment for orthodontic appliances, such as orthodontic braces, retainers, or other oral health devices, and a method of removably attaching the attachment to the orthodontic appliances, is disclosed.

### CROSS-REFERENCE TO RELATED APPLICATION

This application claims priority of provisional patent application Ser. No. 60/759,317, filed Jan. 17, 2006, and is a continuation-in-part application of U.S. utility patent application Ser. No. 11/120,823, filed May 3, 2005, which claimed priority of provisional patent application S No. 60/573,704.

### FEDERALLY SPONSORED RESEARCH OR DEVELOPMENT

Not Applicable.

### TECHNICAL FIELD

This invention generally relates to attachments to an orthodontic appliance, such as orthodontic braces, a retainer, or other oral health device, and, more particularly, to a method and apparatus enabling decorative, aesthetic and/or protective attachments for the bracket or wire of the orthodontic appliance.

### BACKGROUND OF THE INVENTION

Individuals exert significant efforts and use various means to hide or minimize the apparent unsightliness of the orthodontic appliance and/or differentiate, visually enhance and display the orthodontic appliance in a personalized manner. Indeed certain apprehensions associated with wearing the orthodontic appliance, particularly by children and young adults, may be minimized when orthodontists and other oral health professionals use colors, designs, or other features to distinguish and personalize the orthodontic appliance. Existing options for differentiation include colored elastomeric ties, objects affixed to orthodontic braces using intertwining wires, or colored orthodontic appliance material. However the existing options often require the oral health professional's assistance in order to modify the distinguishing feature and in some instances (e.g., colored orthodontic appliance material), the distinguishing feature cannot be modified without substantial expense.

Patients, especially children and young adults, often change such patients' preferences over the months, if not years, that the patients need to wear the orthodontic appliance. Therefore, it would be preferable to have a low cost apparatus that can allow the patients more freedom in the choices of differentiating and personalizing the patients' orthodontic appliances.

The present invention is provided to address these and other issues.

### BRIEF DESCRIPTION OF THE DRAWINGS

FIGS. 1a, 1b and 1c are drawings of respective side, front (i.e., view looking into the mouth of a patient) and rear views of a first version of a first embodiment of the apparatus in the shape of a donut.

FIG. 1d is a drawing of another front view of the first version of the first embodiment of the apparatus as illustrated with orthodontic braces on a pair of teeth.

FIGS. 2a, 2b and 2c are drawings of respective side, front and rear views of a second version of the first embodiment of the apparatus in a cylindrical or elongate shape.

FIGS. 3a, 3b, 3c, 3d and 3e are drawings of side, front, rear, side and rear views of a fourth version of the first embodiment of the apparatus in the shape of two or more donuts, each donut having the entry to receive the wire, connected by an outer surface.

FIGS. 4a, 4b, 4c and 4d are drawings of side, front, rear and front (illustrated with teeth) views of a first version of a second embodiment of the apparatus having a hook to attach directly to a bracket.

FIGS. 5a, 5b, 5c and 5d are drawings of side, front, rear and front views of a second version of the second embodiment of the apparatus having a bar to attach directly to the bracket.

FIGS. 6a, 6b, 6c, 6d, 6e and 6f are drawings of side, front, side, front, and two top views of a third version of the second embodiment of the apparatus having an engaging opening to attach directly to the bracket.

FIGS. 7a and 7b are front and rear perspective drawings of a fourth embodiment of the invention.

FIGS. 8a, 8b and 8c are respective side, top and perspective views of a fifth embodiment of the invention.

FIGS. 9a, 9b and 8c are respective side, top and perspective views of a sixth embodiment of the invention.

FIGS. 10a, 10b and 10c are respective side, top and perspective views of a seventh embodiment of the invention.

FIGS. 11a, 11b and 11c are respective side, top and perspective views of an eighth embodiment of the invention.

FIGS. 12a, 12b and 12c are respective side, top and perspective views of a ninth embodiment of the invention.

FIGS. 13a, 13b and 13c are respective side, top and perspective views of a tenth embodiment of the invention.

FIGS. 14a, 14b and 14c are respective side, top and perspective views of an eleventh embodiment of the invention.

FIGS. 15a and 15b are respective side and perspective views of a twelfth embodiment of the invention.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

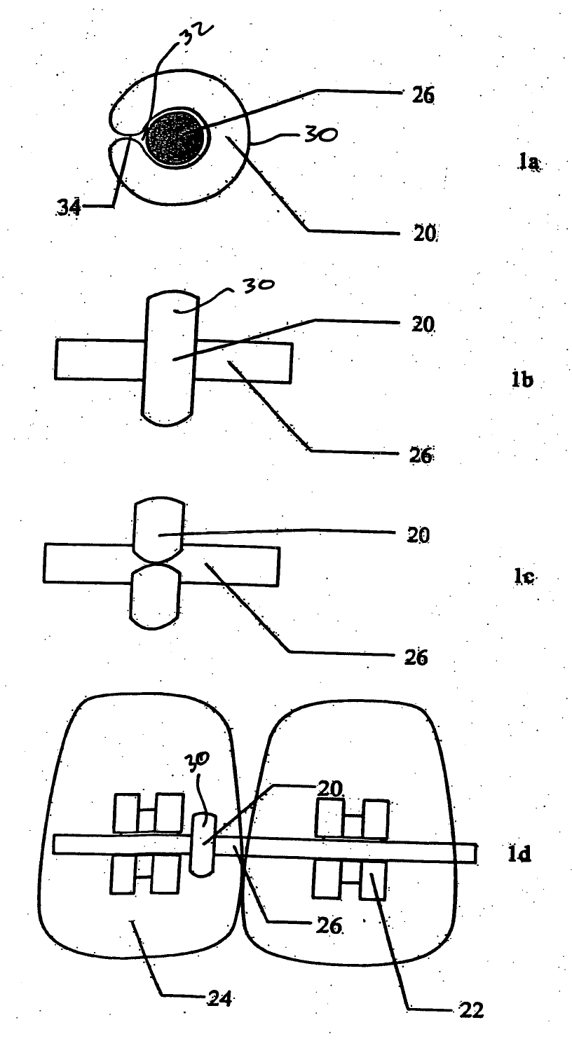

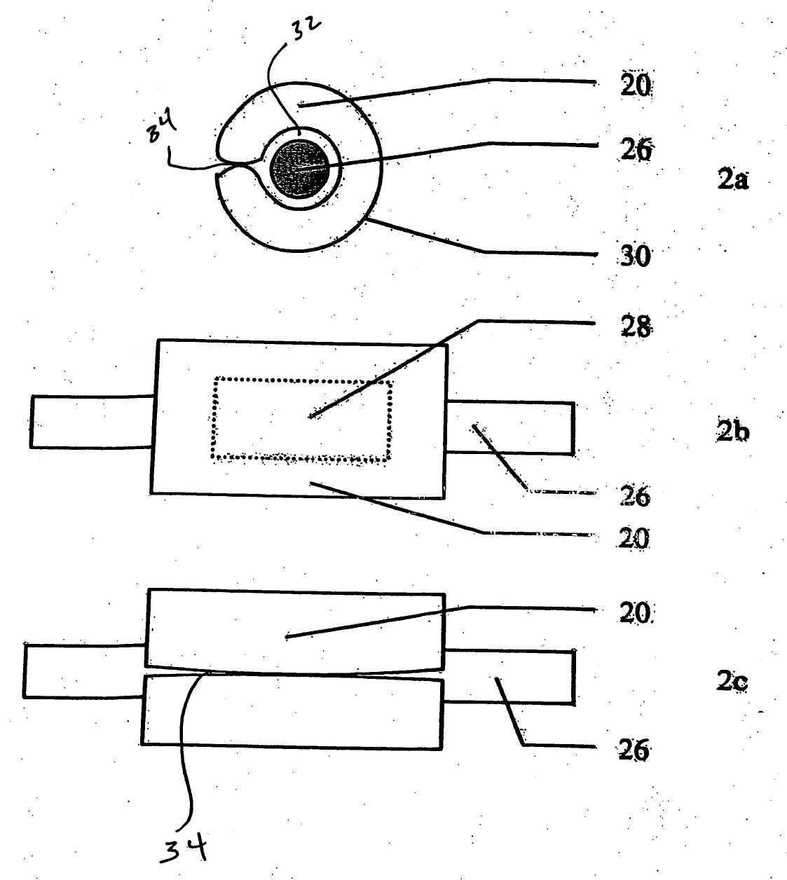

Referring to FIG. 1d, orthodontic braces typically include a plurality of brackets 22 attached to a patient's teeth 24 interconnected by a wire 26. Other orthodontic appliances include some or all of the elements identified in the orthodontic braces. For example, retainers have the wire 26.

The invention, as illustrated herein in various embodiments, is an apparatus 20 that can be attached to, and a method enabling the apparatus 20 to attach to, orthodontic braces or other orthodontic appliances.

As discussed below, the apparatus 20 can preferably be made using plastic or other inexpensive rigid material or a somewhat flexible material. Certain embodiments can be preferably also be made with an elastomeric material.

The apparatus 20 can be made with, or be susceptible to embody, one or more shapes, heights, lengths, colors, designs, letters, numbers, pictures, drawings, trademarks, logos, and/or other distinguishing or differentiating features. For example, the patient could spell a word or name, depict a jersey number or graduation year, or depict the patient's favorite or school colors. One of the differentiating features includes a circular, square, rectangular, or other shaped opening or window 28 allowing a front view of all or a portion of the plurality of the brackets 22 and/or the wire 26. An oral health professional may give the patient a packet containing a sufficient number of one or more varying embodiments of the apparatus 20 with differentiating features. The apparatus 20 can then be applied, sometimes without the oral professional's assistance, with a reasonable amount of pressure and easily changed, mixed, matched and replaced with one or more apparatuses 20 with a different differentiating feature depending upon the patient's preference.

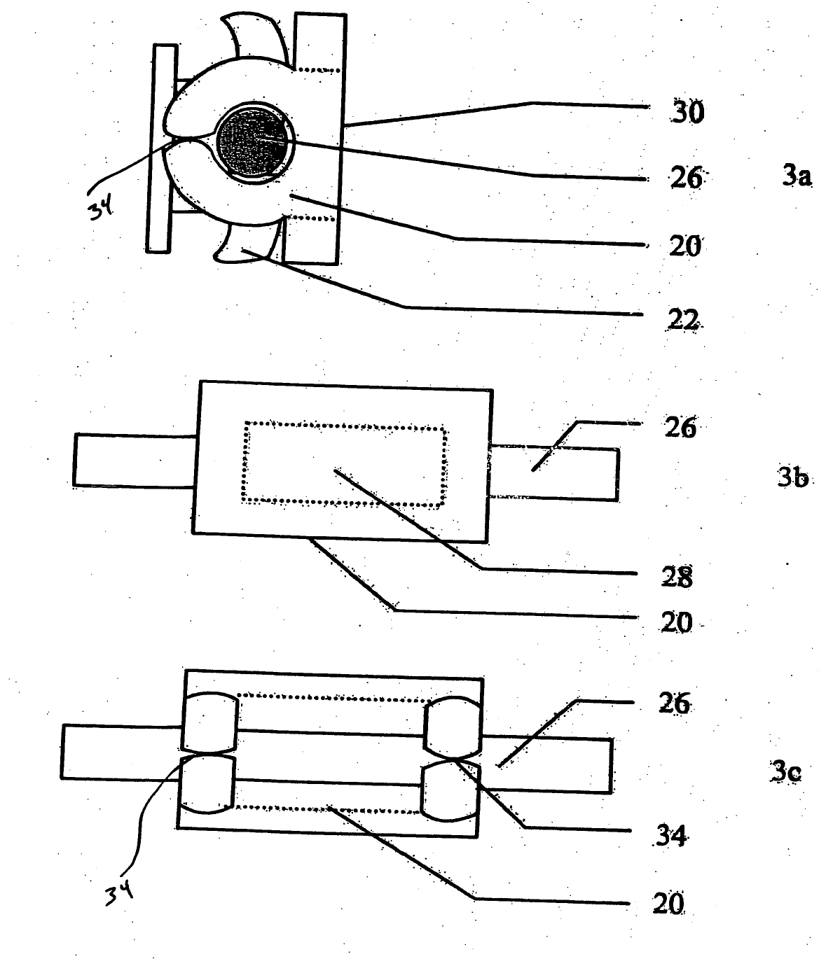

First and second versions of a first embodiment of the apparatus 20 are illustrated in FIGS. 1a-1d and 2a-2c, respectively. The first version of the first embodiment includes an outer surface 30, a lumen 32, and a slit, gap or other entry 34 extending between the outer surface 30 and the lumen 32. The entry 34 receives the wire 26 into the lumen 32 for retaining the apparatus 20 on the wire 26. The entry 34 may be formed by overlapping, inter-locked, laterally positioned, parallel positioned, or other positioned ends.

In FIGS. 1a, 1b, and 1c, side, front (i.e., viewing looking into the mouth of the patient) and rear views, respectively, of the first version of the first embodiment of the apparatus 20 are illustrated in the shape of a donut. The apparatus 20 has the entry 34 to allow the apparatus 20 to attach directly to the wire 26 by slipping the apparatus 20 over the wire 26 and receiving the wire 26 into the lumen 32 so that the apparatus 20 rests on the wire 26. This shape of the embodiment of the apparatus 20 is primarily decorative and allows the patient to attach one or more apparatuses 20, each or all of the apparatuses 20 having one or more differentiating features. In FIG. 1d, another front view of the first embodiment of the apparatus 20 is illustrated in reference to the teeth 24, the bracket 22 and the wire 26.

In FIGS. 2a, 2b and 2c, side, front and rear views, respectively, of the second version of the first embodiment of the apparatus 20 are illustrated in the shape of a cylindrical or elongate shape with an optional window 28 illustrated in phantom. This embodiment of the apparatus 20 is similar to the illustrations identified in FIGS. 1a-1d, but provides a greater outer surface 30 to cover more wire 26 and allow more options with respect to distinguishing features.

The embodiments illustrated in FIGS. 1a-1c and 2a-2c can preferably be made with a rigid polymer, such as Acetal, such as that sold by E.I. duPont de Nemours and Company under the trademark Delrin®. They may also be made with a more flexible plastic.

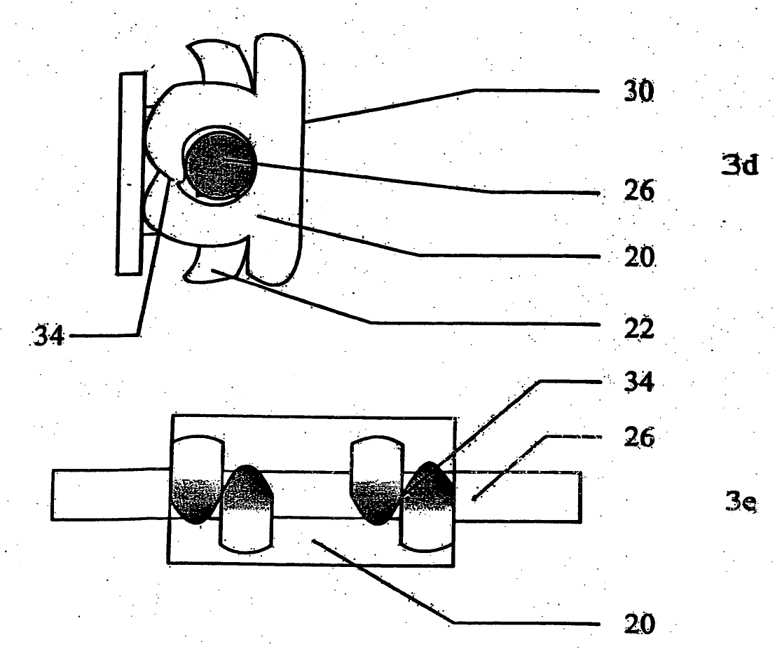

In FIGS. 3a, 3b and 3c, side, front and rear views, respectively, of a fourth version of the first embodiment of the apparatus 20 are illustrated in the shape of two or more connected donuts with the entry 34 on each donut to allow the apparatus 20 to attach directly to the wire 26. Similar to the views illustrated in FIGS. 1a-2c, the entry 34 allows the apparatus 20 to attach directly to the wire 26 by slipping the apparatus 20 over the wire 26, receiving the wire 26 into the lumen 32 and resting the apparatus 20 on the wire 26. The apparatus 20 may be placed between a plurality of brackets 22 to cover more wire 26. The apparatus 20 may also be placed on each side of one or more brackets 22 to cover one or more brackets 22. The connecting outer surface 30 allows for more options with respect to distinguishing features. For example the dotted lines of FIGS. 3a and 3c show optional height variations of the outer surface 30 and FIG. 3b shows an optional window 28.

In FIGS. 3d and 3e, side and rear views, respectively, of a fifth version of the first embodiment of the apparatus 20 show a variation wherein the entry 34 is formed by overlapping ends of the apparatus 20, allowing the apparatus 20 to attach directly to the wire 26 in a more secure manner.

The embodiments illustrated in FIGS. 3a-3e can preferably be made with a rigid polymer, such as Acetal, such as that sold by E.I. duPont de Nemours and Company under the trademark Delrin®. They may also be made with a more flexible plastic.

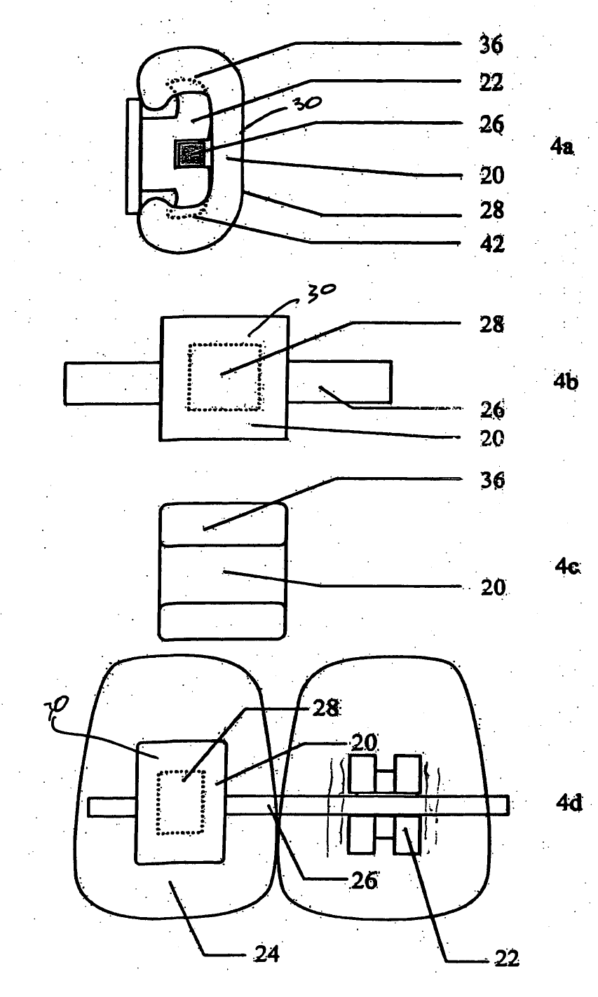

Three versions of a second embodiment of the apparatus 20 are illustrated in FIGS. 4a-4d, 5a-5d and 6a-6e, respectively. Each of the three versions of the second embodiment of the apparatus 20 includes the outer surface 30 and an upper and lower engaging member, such as a hook 36 in a first version, a bar 38 in a second version and an engaging opening 40 in a third version. The upper and lower engaging member engages and secures the apparatus 20 to the upper and lower portion of the bracket 22. This second embodiment of the apparatus 20 enables attachment directly to the bracket 22 in a manner that would not cause interference with the wire 26.

In FIGS. 4a, 4b, and 4c, side, front and rear views of the first version of the second embodiment of the apparatus 20 are illustrated in the shape of a backward letter C, the upper hook 36 engaging above and behind a top portion of the bracket 22 and the lower hook 36 engaging below and behind the lower portion of the bracket 22. This embodiment of the apparatus 20 is much like a cap over the bracket 22 and is not intended to cause interference with the wire 26. The outer surface 30 will be the portion seen by others when the patient smiles and can be used to depict various differentiating features. Furthermore, the apparatus 20 may hide certain unaesthetic aspects of the bracket 22. FIG. 4a shows an optional block 42 on width ends of the apparatus 20 encapsulating the side width ends of the upper and lower portions of the bracket 22. The optional block 42 minimizes side-to-side movement of the apparatus 20 from the bracket 22. FIG. 4b shows an optional window 28. In FIG. 4d, another front view of the second embodiment of the apparatus 20 is illustrated in reference to the teeth 24, the bracket 22 and the wire 26, along with the optional window 28.

The embodiments illustrated in FIGS. 4a-4d can preferably be made with a rigid polymer, such as Acetal, such as that sold by E.I. duPont de Nemours and Company under the trademark Delrin®. They may also be made with a more flexible plastic.

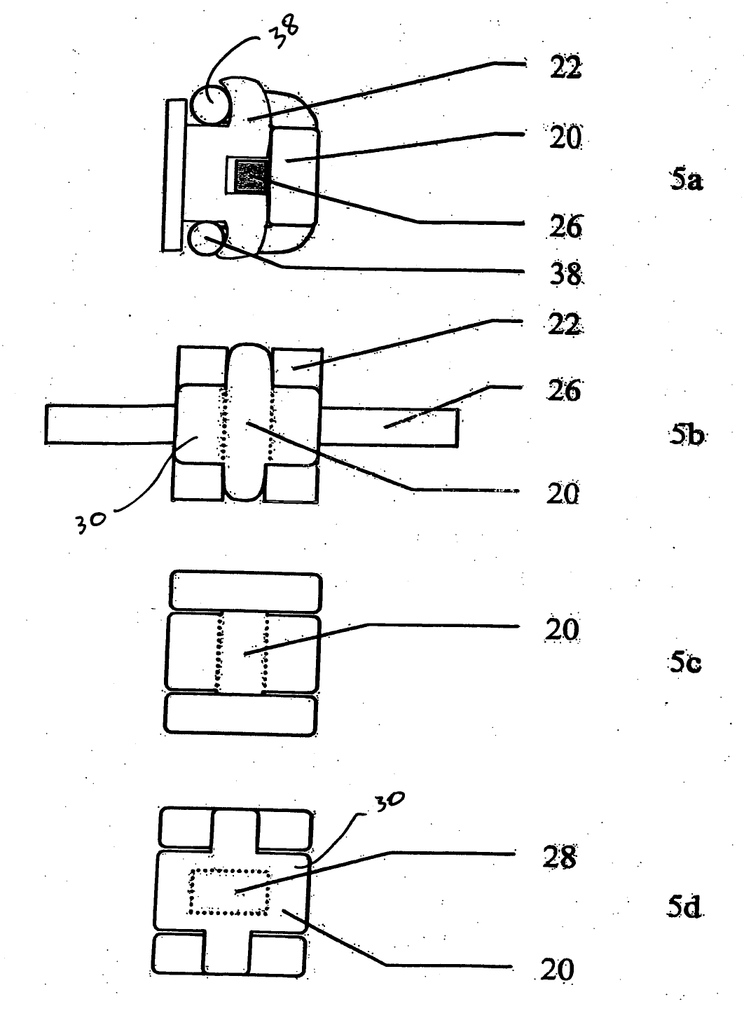

In FIGS. 5a, 5b, 5c and 5d, side, front, rear and other front views of the second version of the second embodiment of the apparatus 20 are illustrated in the shape of a backward letter C similar to the embodiment of the apparatus 20 illustrated in FIGS. 4a-4c. However this embodiment of the apparatus 20 includes a t-shaped top bar 38 for engaging between and behind the top portion of the bracket 22 and a t-shaped bottom bar 38 engaging between and behind the lower portion of the bracket 22. In these views, the top and bottom bars 38 fit securely behind the top and lower portion of the bracket 22. FIGS. 5b and 5c shows an optional larger width in the middle portion of the apparatus 20, allowing a greater surface area. FIG. 5d shows an optional window 28.

The embodiments illustrated in FIGS. 5a-5d can preferably be made with a rigid polymer, such as Acetal, such as that sold by E.I. duPont de Nemours and Company under the trademark Delrin®. They may also be made with a more flexible plastic.

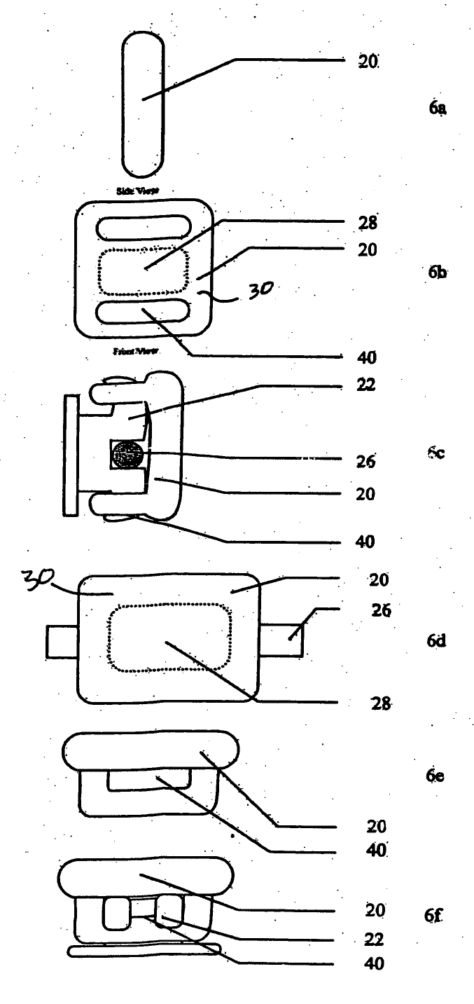

In FIGS. 6a, 6b, 6c, 6e, 6d, 6e and 6f, side, front, another side, another front, and two top views of the third version of the second embodiment of the apparatus 20 are illustrated which include an upper and lower engaging opening 40. When flexibly bent or stretched, the upper engaging opening 40 engages around and behind the upper portion of the bracket 22 by receiving the upper portion of the bracket 22, allowing the upper portion of the bracket 22 to fit securely in the engaging opening 40. Similarly, the engaging opening 40 engages around and behind the lower portion of the bracket 22 by receiving the lower portion of the bracket 22, allowing the lower portion of the bracket 22 to fit securely in the engaging opening 40.

FIGS. 6b and 6d show the optional window 28. FIGS. 6c, 6e and 6f show an optional taller outer surface to hide a greater portion of the bracket 22 and allow for a larger outer surface 30.

A third embodiment of the apparatus 20 includes the outer surface 30, one or more distinguishing features, such as the window 28, embodied on the outer surface 30 and a temporary glue or other adhesive 44 on the back side of the outer surface 30. The temporary adhesive attaches the apparatus 20 to the bracket 22, the second embodiment of the apparatus 20, or another object attached to the bracket 22 or wire 26.

The embodiments illustrated in FIGS. 6a and 6b can be preferably made of an elastomeric material. The embodiments of FIGS. 6c-6f can also be preferably made of an elastomeric material. Additionally these embodiments can preferably be made with a rigid polymer, such as Acetal, such as that sold by E.I. duPont de Nemours and Company under the trademark Delrin®. They may also be made with a more flexible plastic.

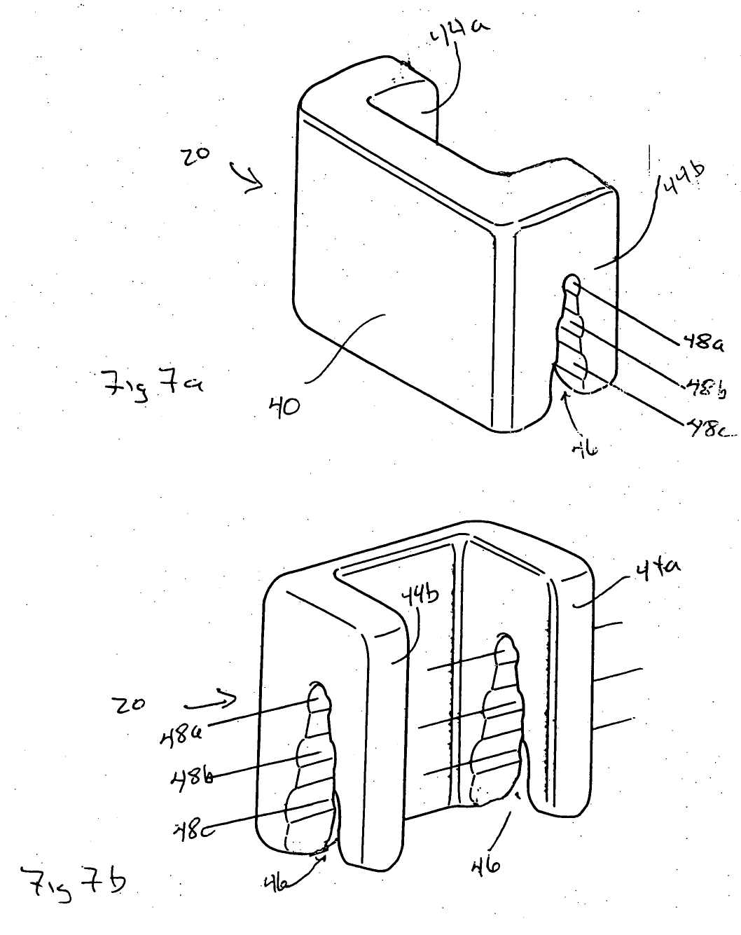

Apparatuses illustrated in FIGS. 7-11 and 15 illustrate various embodiments having one or more shoulders to engagingly receive the wire.

A fourth embodiment of the apparatus 20 is illustrated in FIGS. 7a and 7b. The apparatus 20 is preferably formed of a rugged, generally inflexible polymer, such as that sold by E.I. duPont de Nemours and Company under the trademark Delrin®. They may also be made with a more flexible plastic.

The apparatus 20 straddles the bracket 22 and engages the wire 26. The apparatus 20 has a front portion 40. The apparatus 20 further includes two wings 44a and 44b. Each of the wings a notch 46. Inner surfaces of the notches 46 are shaped to form a generally cylindrical upper channel 48a, middle channel 48b and lower channel 48c.

Often orthodontists use wires of different diameters, depending on the tension to be placed on the wire. The middle channel 48b is larger than the upper channel 48a and the upper channel 48c is larger than the middle channel 48b. This permits the upper channel 48a to securely receive and retain wires of relatively small diameters, the middle channel 48b to securely receive and retain wires of relatively mid-sized diameters and the lower channel 48c to securely receive and retain wires of relatively large diameter.

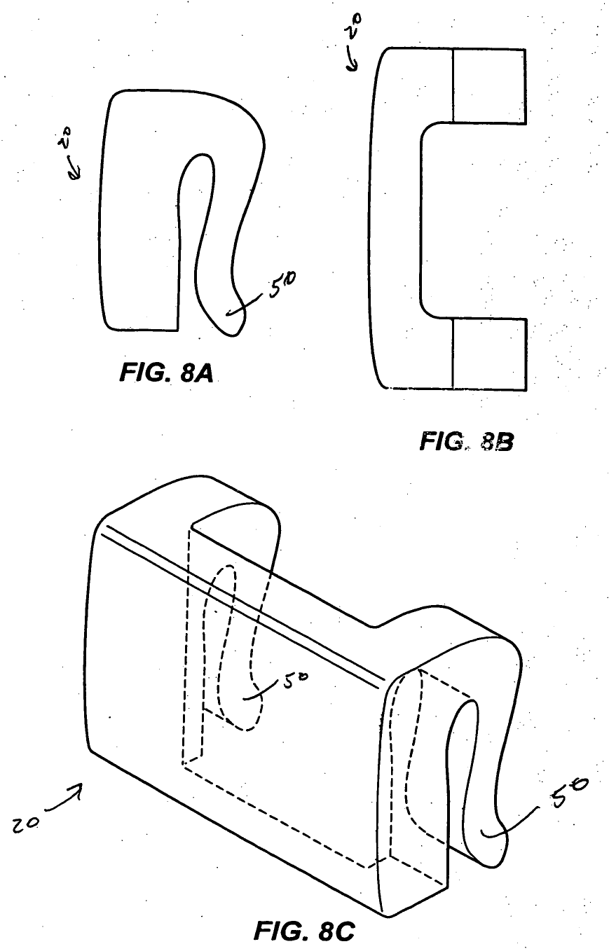

A fifth embodiment of the invention is illustrated in FIGS. 8a-8c. This embodiment is similar to that of the fourth embodiment, but has two curved legs 50 to engage the wire 26.

This embodiment is preferably formed of a rugged, generally inflexible polymer, such as that sold by E.I. duPont de Nemours and Company under the trademark Delrin®. It may also be made with a more flexible plastic.

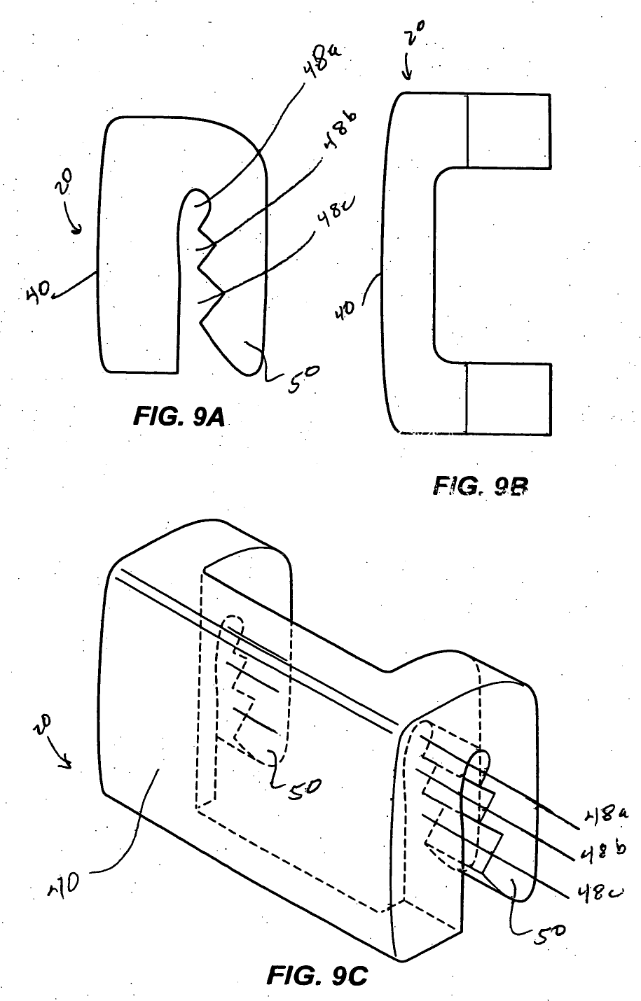

A sixth embodiment of the invention is illustrated in FIGS. 9a-9c. This embodiment is similar to that of the fourth embodiment, but has two legs 50 having a generally saw-toothed profile to engage the wire 26.

This embodiment is preferably formed of a rugged, generally inflexible polymer, such as that sold by E.I. duPont de Nemours and Company under the trademark Delrin®. It may also be made with a more flexible plastic.

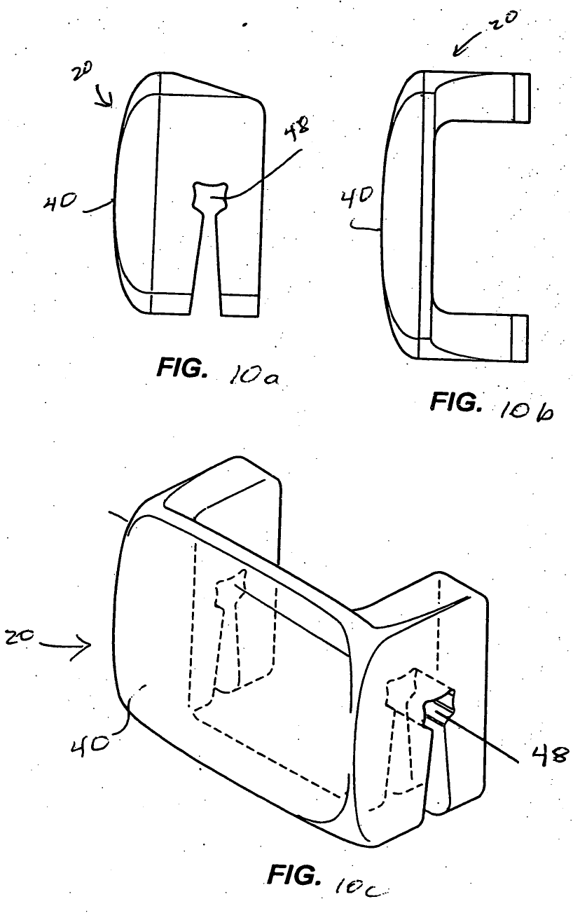

A seventh embodiment of the invention is illustrated in FIGS. 10a-10c. This embodiment is similar to that of the fourth embodiment, but the inner surfaces of the notches 46 are shaped to form a generally square channel 48 to engage the wire 26.

This embodiment is preferably formed of a rugged, generally inflexible polymer, such as that sold by E.I. duPont de Nemours and Company under the trademark Delrin®. It may also be made with a more flexible plastic.

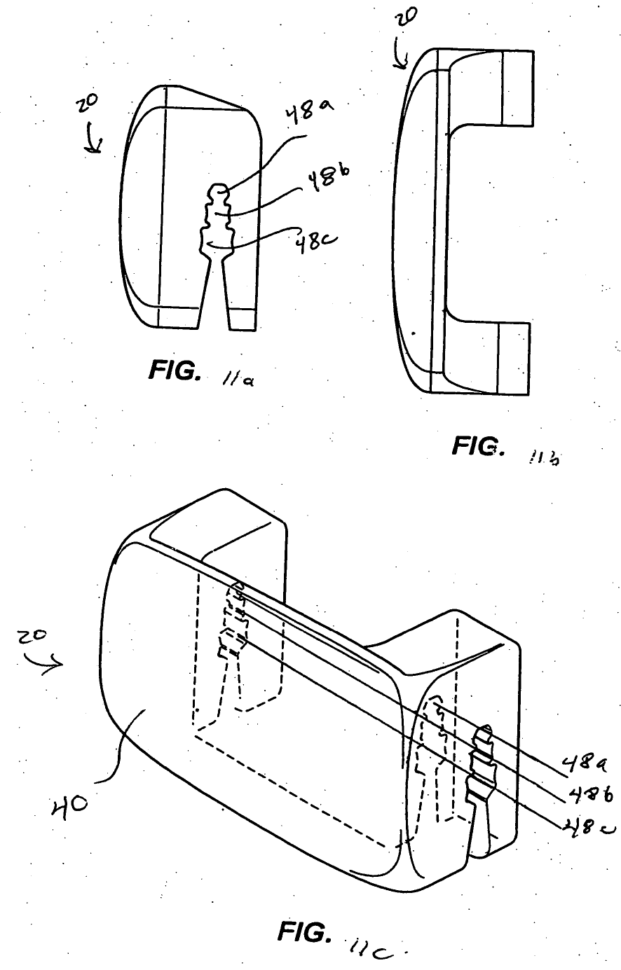

An eighth embodiment of the invention is illustrated in FIGS. 11a-11c. This embodiment is similar to that of the seventh embodiment, but the inner surfaces of the notches 46 are shaped to form three generally square channels 48a, 48b and 48c to engage the wire 26.

This embodiment is preferably formed of a rugged, generally inflexible polymer, such as that sold by E.I. duPont de Nemours and Company under the trademark Delrin®. It may also be made with a more flexible plastic.

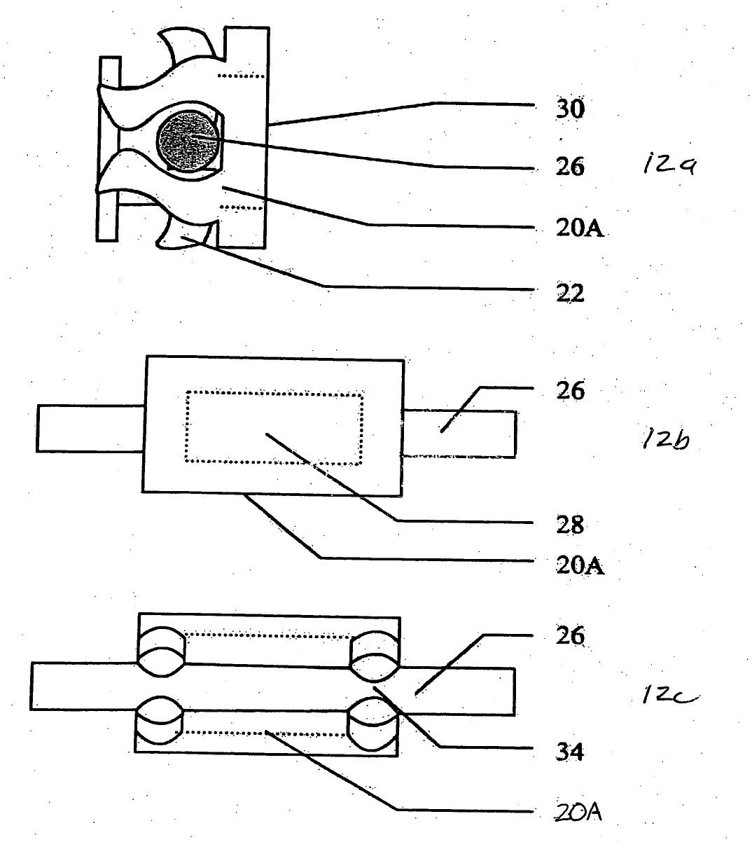

A ninth embodiment of the invention is illustrated in FIGS. 12a-12c. This embodiment is similar to the embodiment of FIGS. 3a-3a, but which leg 50 is shaped differently to engage the wire 26.

This embodiment is preferably formed of a rugged, generally inflexible polymer, such as that sold by E.I. duPont de Nemours and Company under the trademark Delrin®. It may also be made with a more flexible plastic.

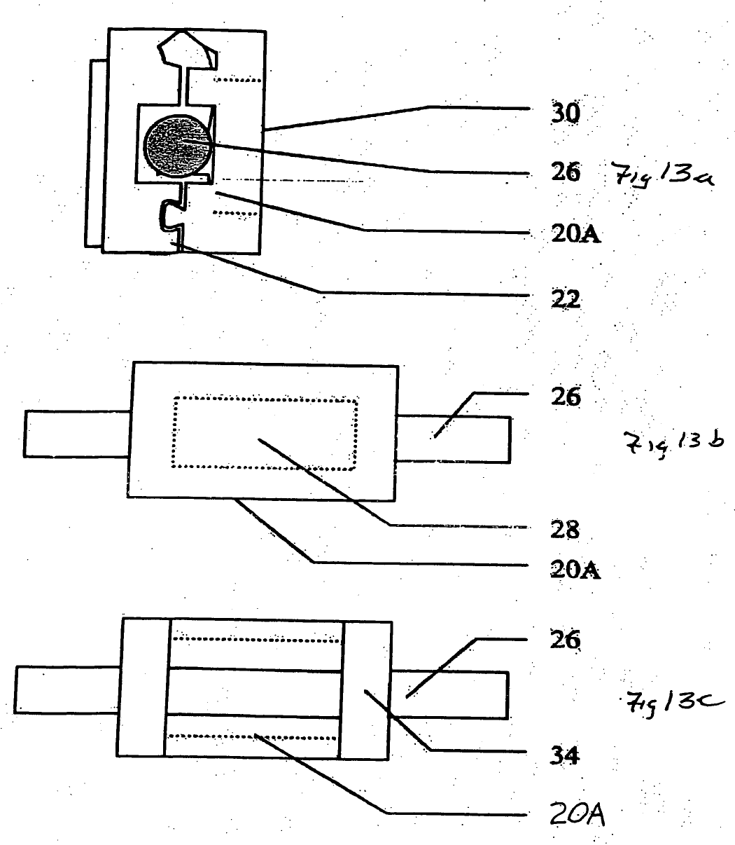

A tenth embodiment of the invention is illustrated in FIGS. 13a-13c. In this embodiment the apparatus includes a pivot joint 52 to permit the apparatus to open to clear the wire 26. The apparatus further includes a latching mechanism 54 to keep the apparatus closed when placed over the wire 26.

This embodiment is preferably formed of a rugged, generally inflexible polymer, such as that sold by E.I. duPont de Nemours and Company under the trademark Delrin®. It may also be made with a more flexible plastic.

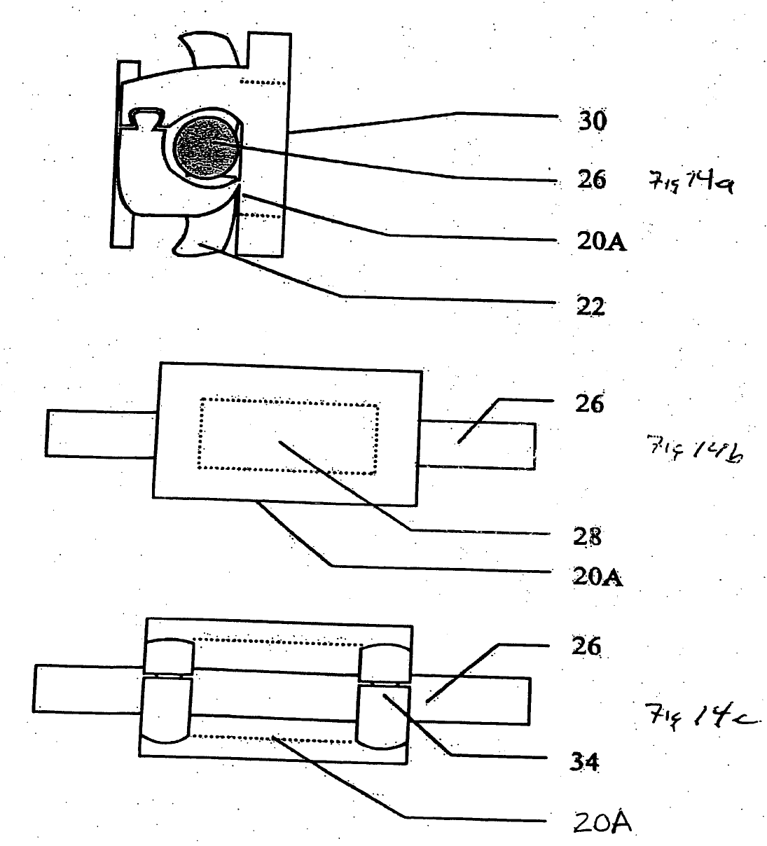

An eleventh embodiment of the invention is illustrated in FIGS. 14a-14c. This embodiment is similar to that of the tenth embodiment, although the locations of the pivot joint 52 and latching mechanism 54 have been moved.

This embodiment is preferably formed of a rugged, generally inflexible polymer, such as that sold by E.I. duPont de Nemours and Company under the trademark Delrin®. It may also be made with a more flexible plastic.

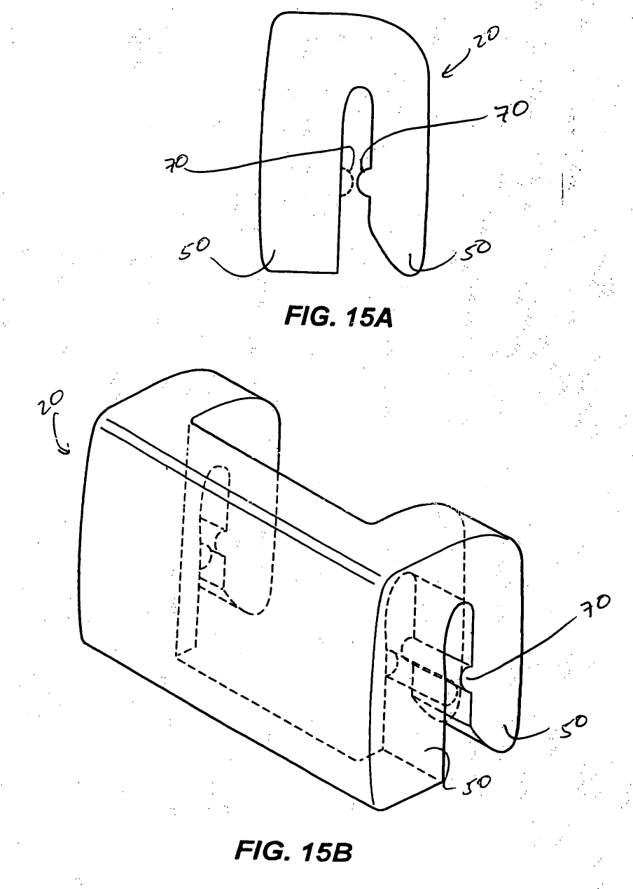

A twelfth embodiment of the invention is illustrated in FIGS. 15a and 15b. According to this embodiment, one or both of the legs 50 (one is illustrated in phantom) include a bump 70 to form a shoulder to engage the wire 26.

As with the embodiments described above, one or more distinguishing features may be applied to the front portion 40. For example, the outer surface 30 may be of other shapes, such as oval. Windows 28 may be provided on any of the embodiments, as desired.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. For an orthodontic appliance including a bracket and a wire, an attachment for placement over the wire comprising:
a front portion adapted for placement in front of the bracket; and
first and second wing portions, wherein at least one of the wing portions includes a shoulder to engagingly receive the wire.

2. The attachment of claim 1 wherein both of the wing portions includes a shoulder to engagingly receive the wire.

3. The attachment of claim 1 wherein the wing portions include a respective inner surfaces, and at least one of the inner surfaces is shaped to define a channel to form the shoulder.

4. The attachment of claim 3 wherein the channel is generally arcuate.

5. The attachment of claim 3 wherein the channel is generally orthogonal.

6. The attachment of claim 1 wherein each of inner surfaces is shaped to define a channel.

7. The attachment of claim 6 wherein the channel is generally arcuate.

8. The attachment of claim 6 wherein the channel is generally orthogonal.

9. The attachment of claim 1, wherein the front portion includes a distinguishing feature.

10. The attachment of claim 9, wherein the distinguishing feature comprises a window extending through the front portion.

11. For an orthodontic appliance including a bracket and a wire, an attachment for placement over the wire comprising:
a front portion adapted for placement in front of the bracket; and
a rear portion adapted for placement behind the bracket; and
a pivot joint pivotally joining the front portion to the rear portion;
wherein the front portion and the rear portion include a cooperatively engaging latching mechanism to latch the front portion to the rear portion to maintain the apparatus closed when placed over the wire.

12. The attachment of claim 11, wherein the front portion includes a distinguishing feature.

13. The attachment of claim 12, wherein the distinguishing feature comprises a window extending through the front portion.
